(19) United States
(12) Patent Application Publication
(10) Pub. No.: US 2011/0044554 A1
(43) Pub. Date: Feb. 24, 2011

(54) ADAPTIVE DEBLURRING FOR CAMERA-BASED DOCUMENT IMAGE PROCESSING

(75) Inventors: Yibin TIAN, Menlo Park, CA (US); Wei MING, Cupertino, CA (US)

Correspondence Address: Chen Yoshimura LLP;Attention Ying Chen, 333 W. El Camino Real, Suite 380, Sunnyvale, CA, 94087, US

(73) Assignee: KONICA MINOLTA SYSTEMS LABORATORY, INC., Huntington Beach, CA (US)

(21) Appl. No.: 12/633,316

(22) Filed: Dec. 8, 2009

Related U.S. Application Data
(60) Provisional application No. 61/236,077, filed on Aug. 21, 2009.

(51) Int. Cl. G06K 9/40; H04N 1/38; H04M 1/02

(52) U.S. Cl. 382/255; 358/463; 455/556.1

(57) ABSTRACT

An image deblurring method for camera-based document image processing is described. A document image captured by a digital camera is divided into multiple overlapping or non-overlapping sub-images. A point spread function is derived for each sub-image by analyzing the gradient information along edges contained in the sub-image. Each sub-image is deblurred by using its local point-spread function. The whole deblurred image is constructed from deblurred sub-images. In cases where information of interest is located in localized parts of the document image, dividing the image into sub-images may be done by extracting the area of interest from the captured image. This deblurring method improves the quality of the deblurred image when the camera-captured image is blurred by variable amount of location-dependent defocus.

This application claims priority under 35 USC §119(e) from U.S. Provisional Patent Application No. 61/236,077, filed 21 Aug. 2009, which is herein incorporated by reference in its entirety.

### BACKGROUND OF THE INVENTION

1. Field of the Invention

This invention relates to image processing, and in particular, it relates to a process for deblurring an image captured by a digital camera.

2. Description of Related Art

With rapid advances in consumer electronics, many multifunctional electronic devices have emerged in the past few years. The combination of digital cameras and cellular phones is particularly popular, and is enabling many social and cultural changes. In addition to the dramatically increased availability, the resolution of phone cameras has also been increasing steadily in the past few years. Now phone cameras with 8 megapixel sensors are widely available from multiple manufacturers. With such a resolution, it is possible to obtain document images at resolutions about 300 dpi for papers of a common size (e.g. letter or A4 size) without image mosaicking. With increased resolution of mobile imaging devices, coupled with their increased computing power, camera-based document image processing (CBDIP) is becoming more and more attractive.

In this disclosure, document image processing or analysis generally refers to analysis of images containing text information. Conventionally, document image processing uses a scanner (e.g. a flatbed scanner) or a special purpose document camera to capture a digital image of a document. CBDIP has several advantages as compared to traditional scanner-based image capture approach. Cameras on mobile devices, particularly phone cameras, are non-contact. They are also inherently connected to wireless communication networks, are widely available and portable. All these factors offer potentially wider and more efficient applications for CBDIP than a scanner-based approach. For example, CBDIP systems can be used as a text recognizer and reader for the visually impaired (see, for example, Shen, H., Coughlan, J.: Grouping Using Factor Graphs: an Approach for Finding Text with a Camera Phone, Lecture Notes in Computer Science, Vol. 4538. Springer-Verlag, Berlin Heidelberg N.Y. (1995) 394-403), a hand-held foreign language sign translator (see, for example, Yang, J., Gao, J., Zhang, Y., Waibel A.: Towards Automatic Sign Translation. Proceedings of Human Language Technology (2001) 269-274), and a cargo container label reader (see, e.g., Lee, C. M., Kankanhalli, A.: Automatic Extraction of Characters in Complex Scene Images, International Journal of Pattern Recognition and Artificial Intelligence (1995) 67-82). Optical Character Recognition (OCR) is one of the most common document processing tasks, and it has been shown that PC camera-based OCR is more productive than scanner-based OCR for processing newspaper text (see, e.g., Newman, W., Dance, C., Taylor A., Taylor, S, Taylor, M., Aldhous, T.: CamWorks: A Video-based Tool for Efficient Capture from Paper Source Documents. Proceedings of IEEE International Conference on Multimedia Computing and Systems (1999) 647-653).

While offering flexibility and other advantages, CBDIP is associated with a number of challenges, such as non-uniform illumination, perspective distortion, zooming and focusing, object motion, and limited computing power. See, for example, Doermann, D., Liang, J., Li, H.: Progress in Camera-Based Document Image Analysis, Proceedings of the International Conference on Document Analysis and Recognition (2003) 606-616.

For example, when imaging targets are positioned with a significant depth variation from the camera due to physical constraints, the camera-captured image is blurred by variable amounts of location-dependent defocus. The problem is particularly severe when the imaging targets are very close to the camera or the camera's depth of focus is small, which conditions are frequently encountered in CBDIP due to magnification and field of view considerations. In the simplest case of a two-depth scene consisting of two targets of interest, it can be shown that the difference between the ideal image depths is

$$δ = \vert {d}_{1}^{i} - {d}_{2}^{i} \vert = \vert \frac{{f}^{2} ( {d}_{1}^{o} - {d}_{2}^{o} )}{( {d}_{1}^{o} - f ) ( {d}_{2}^{o} - f )} \vert$$

where d₁ⁱ and d₂ⁱ are the image distances of the two targets, d₁^{o} and d₂^{o} their object distances respectively, and f the focal length of the camera lens. See Tian, Y., Feng, H., Xu, Z., Huang, J.: Dynamic Focus Window Selection Strategy for Digital Cameras, Proceedings of SPIE, Vol. 5678 (2005) 219-229 (hereinafter “Tian et al. 2005”). It is likely that both targets will be out of focus if they are both located within the focus window, and the exact defocus amount of each target is dependent on their relative sizes in the focus window. See Tian et al. 2005; Tian, Y.: Dynamic Focus Window Selection Using a Statistical Color Model, Proceedings of SPIE, Vol. 6069 (2006) 98-106.

FIG. 2(a) shows a document image captured by a digital camera. FIG. 2(b) schematically illustrates the target-camera configuration used to take the image of FIG. 2(a). FIG. 2(c) is a magnified view of the marked portion of the document image shown in FIG. 2(a). The example of the document image shown in FIG. 2(a) is intended to show some issues that frequently arise in camera-based document images, including nonuniform illumination, perspective distortion and continuous depth variations.

### SUMMARY

Accordingly, the present invention is directed to an image processing method that substantially obviates one or more of the problems due to limitations and disadvantages of the related art.

An object of the present invention is to provide an image processing method that enhances image quality and reduces the adverse effect of variable and location-dependent defocus in CBDIP.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a data processing system for processing a document image, comprising: (a) obtaining a plurality of sub-images from the document image; and (b) for each sub-image, (b1) detecting a plurality of edges in the sub-image; (b2) obtaining edge response functions by analyzing image intensity variations across the detected edges; (b3) calculating two-dimensional point-spread function from the edge response functions; and (d4) deblurring the sub-image by applying deconvolution with the calculated point-spread function.

In another aspect, the present invention provides a computer program product that causes a data processing apparatus to perform the above method.

In another aspect, the present invention provides a mobile device which includes: an image capturing section for capturing an image; and a processing section for processing the captured image, wherein the processing section obtains a plurality of sub-images from the document image, and for each sub-image, the processing section detects a plurality of edges in the sub-image, obtains edge response functions by analyzing image intensity variations across the detected edges, calculates two-dimensional point-spread function from the edge response functions, and deblurs the sub-image by applying deconvolution with the calculated point-spread function, wherein the image capturing section and the processing section are contained within a same housing.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a flow chart illustrating an image deblurring method according to an embodiment of the present invention.

FIG. 2(a) shows a document image captured by a digital camera.

FIG. 2(b) schematically illustrates the target-camera configuration used to take the image in FIG. 2(a).

FIG. 2(c) is a magnified view of the marked portion of the document image shown in

FIG. 2(a).

FIG. 3 schematically illustrates a data processing system in which embodiments of the present invention may be implemented.

### DETAILED DESCRIPTION OF PREFERRED EMBODIMENTS

To obtain higher quality images for a camera-captured document image, deconvolution can be utilized to reduce blur in the image. Because the amount of defocus is dependent on location, a single point spread function (PSF) is not a good representation of the imaging system. Embodiments of the present invention provide an adaptive deblurring method to improve the image quality locally.

Optical blurring can be well modeled as low pass filtering that significantly reduces high spatial frequency signals in images. As a result, the impact of defocus on images is most significant on edges. By analyzing the intensity variations across edges in an image, the edge response of the camera can be estimated if it is assumed the edges in the targets (the objects being photographed) are sharp, as is the case in many documents, where characters and the background often form sharp transitions in intensities. Others have described methods by which sharp edges are artificially created in images as targets, and the printed image is scanned back where the edges are used to obtain a PSF for the scanner. See, for example, Smith, E. H. B.: PSF Estimation by Gradient Descent Fit to the ESF, Proceedings of SPIE, Vol. 6059 (2006) 129-137. In embodiments of the present invention, edges (often complex) that naturally exist in the document image itself are utilized to obtain local PSFs for the image.

Optical blurring can be caused by defocus, non-defocus aberrations, light scatter, and the combination of the three. See Tian, Y., Shieh, K., Wildsoet, C. F.: Performance of Focus Measures in the Presence of Non-defocus Aberrations, Journal of the Optical Society of America A (2007) 165-173 (hereinafter “Tian et al. 2007”). Asymmetric PSFs may arise due to significant amount of non-defocus asymmetric aberrations such as astigmatism and coma, but for small amount of non-defocus aberrations in human-designed optical systems such as cameras, their impact on blur is trivial. See Tian et al. 2007. The impact of light scatter is usually rotationally symmetric. For simplicity, in embodiments of the present invention, only optical blurring that is symmetric in at least one dimension is considered, which allows reconstructing two dimensional PSFs from one dimensional edge responses with the assumption that the PSFs are near Gaussian.

Embodiments of the present invention provide a method for adaptively deblurring camera-based document images to improve image quality locally. This method takes advantage of the fact that there is rich edge information in document images, which can be used to derive local PSFs from the gradient variations across well-defined edges, thus deblurring can be locally carried out on sub-images. This process can significantly improve image quality as compared to a conventional deblurring method which uses a single PSF.

In this method, sub-images of interest are first extracted from the captured image, and a point spread function is derived for each sub-image by analyzing the gradient information along edges within the image. Then the sub-image is deblurred using its local point-spread function. This adaptive deblurring method can significantly improve focusing quality as evaluated by both human observers and objective focus measures.

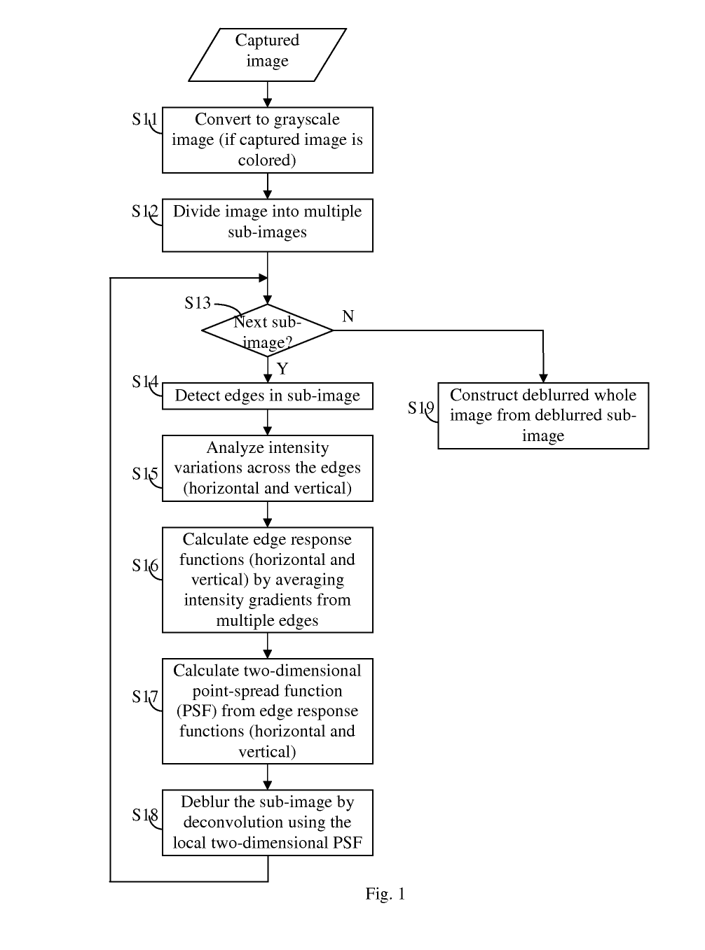

FIG. 1 illustrates a method implemented in a data processing system for deblurring an image using a PSF according to a preferred embodiment of the present invention. First, if a captured image is colored, it is converted to grayscale (e.g. 8-bit grayscale) (step S11). The entire grayscale document image is then divided (segmented) to form a number of sub-images (step S12). The sub-images may overlap with each other or may be non-overlapping. In one preferred embodiment, the sub-images collectively cover the entire image. In other preferred embodiments as will be described in more detail later, the sub-images collectively do not cover the entire image.

The segmentation step S12 is preferably performed automatically by the system. A simple implementation is to divide the image into a pre-defined number of (e.g. N by M) sub-images. A more intelligent image segmentation methods can be utilized, such as text detection (see Shen, H., Coughlan, J.: Grouping Using Factor Graphs: an Approach for Finding Text with a Camera Phone, Lecture Notes in Computer Science, Vol. 4538, Springer-Verlag, Berlin Heidelberg N.Y. (2005) 394-403), depth-based image segmentation, or other advanced pattern recognition methods.

For each sub-image (step S13), an edge detection process is performed to detect edges in the sub-image (step S14). Edges in document images are abundant and easy to detect with most of the common edge detectors, even when the imaged are blurred. Any suitable edge detector algorithm may be used. The intensity variations across a number of edges are analyzed (step S15). Preferably, the edges used for intensity analysis include ones that are substantially non-parallel to each other. Preferably, horizontal and vertical edges are used for this purpose. To reduce the impact of noise and local background, it is preferable to use edges at multiple different locations. Gradients of intensities in the directions perpendicular to the edges are calculated, and the gradients for multiple edges in substantially the same orientations are averaged to calculate the edge response functions for the corresponding directions (step S16). When the edges are generally vertical and horizontal in directions, edge response functions for the horizontal and vertical direction are obtained. The edge response functions may be modeled using suitable functions, such as Gaussian functions, Cauchy functions, etc. A local two-dimensional PSF is calculated by multiplying the edge response functions in two substantially perpendicular directions (preferably horizontal and vertical directions) (step S17). Deblurring is performed on the grayscale sub-image by applying a deconvolution algorithm using the local two-dimensional PSF (step S18).

After all sub-images are deblurred (“N” in step S13), the whole deblurred image is constructed from the deblurred sub-images (step S19). This step is optional. To improve the smoothness of transition at sub-image boundaries, the sub-images preferably overlap each other by a small amount (e.g. tens of pixels). In such a case, the whole deblurred image is constructed from the deblurred sub-images using image mosaicking.

After the deblurred image is constructed, other processing steps may be carried out, such as binarization, OCR, etc.

It is well-known that deblurring using deconvolution is sensitive to noise and prone to artifacts. Iterative search and regularized deconvolution algorithms have been developed to reduce artifacts from deconvolution. One example is the Lucy-Richardson iterative algorithm described in Richardson W H, Bayesian-based Iterative Method of Image Restoration, Journal of the Optical Society of America (1972) 55-59. Any suitable iterative and non-iterative deconvolution algorithm may be used to implement step S18; many such methods have been described and are well-known.

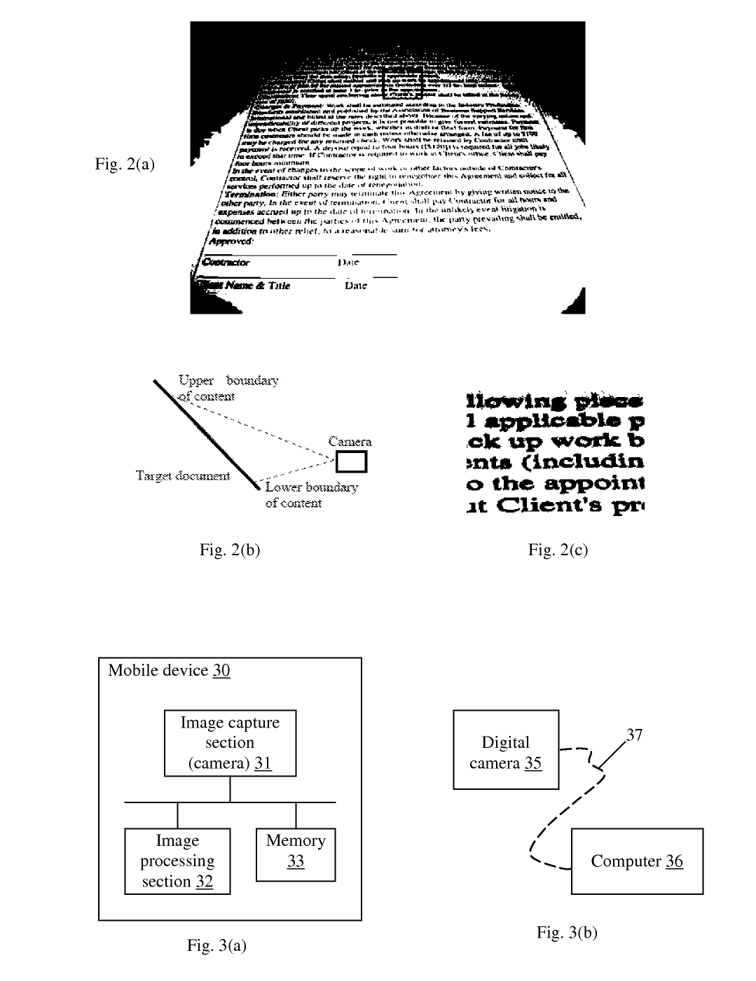

As shown in the exemplary document image in FIG. 2(a), a few issues frequently arise in camera-based document images, such as nonuniform illumination, perspective distortion and continuous depth variations. Additional image processing steps may be performed to deal with these issues.

Non-uniform illumination can arise from using camera flash or ambient light in the field. See Fisher, F.: Digital Camera for Document Acquisition, Proceedings of Symposium on Document Image Understanding Technology (2001) 75-83. As the whole image is divided into a number of sub-images to derive local PSFs in adaptive deblurring, non-uniform illumination may adversely affect the locally derived PSFs. Background removal and/or contrast stretching processes can be utilized to reduce the impact of non-uniform illumination. See Kuo. S., Ranganath, M. V.: Real Time Image Enhancement for both Text and Color Photo Images, Proceedings of International Conference on Image Processing (1995): 159-162. Such a step may be performed before the deblurring process shown in FIG. 1, e.g., before step S12.

Perspective distortions have multiple manifestations in document images. For example, parallel edges in an original document often appear to be non-parallel in the image (see FIG. 2(a)), magnifications may be different in the horizontal and vertical directions due to the difference in lateral and longitudinal magnifications, and the strokes of text may be blurred more in the vertical direction than in the horizontal direction (see FIG. 2(c)). Perspective correction may be accomplished by estimating the horizontal and vertical vanishing points in the image. See Clark, P., Mirmehdi, M.: Recognising Text in Real Scenes, International Journal on Document Analysis and Recognition (2002) 243-257.

Skew may be detected by applying a Hough transform to the centroids of the image components in the captured, as described in Yu, B., Jain, A. K.: A Robust and Fast Skew Detection Algorithm for Generic Documents, Pattern Recognition (1996): 1599-1629, or by applying a Hough transform to the extreme points of image components within the image (top/bottom or left/right depending on orientation).

Perspective and skew corrections may be performed on the document image before the deblurring process shown in FIG. 1 (e.g. before step S11 or S12). If these corrections are performed, edge response functions in the horizontal and vertical direction can be more readily obtained by steps S14 to S16. If these corrections are not performed, edges in various oblique directions (preferably including directions that are perpendicular to each other) may be used to obtain edge response functions and the two-dimensional local PSFs.

In some cases, the information of interest is located in localized parts of the document image. For example, if the objective is to find and recognize road signs in a document image, grouped blocks of characters can be extracted using text classification methods. See Shen, H., Coughlan, J.: Grouping Using Factor Graphs: an Approach for Finding Text with a Camera Phone, Lecture Notes in Computer Science, Vol. 4538, Springer-Verlag, Berlin Heidelberg N.Y. (2005) 394-403. In another application example, the objective is to read a cargo container label (see Lee, C. M., Kankanhalli, A.: Automatic Extraction of Characters in Complex Scene Images, International Journal of Pattern Recognition and Artificial Intelligence (1995) 67-82). In this type of applications, i.e., when the information of interest is localized in the document image, sub-images of interest can be extracted and individually processed. In other words, the step of dividing the image into multiple sub-images (step S12 in FIG. 1) may be implemented by a method of extracting sub-images of interest, such as grouped blocks of characters, using a suitable method such as text classification methods. Then, steps S14 to S18 of FIG. 1 are performed for each such sub-image to obtain a local PSF the sub-image and to deblur the sub-image. The extracted sub-images typically do not collectively cover the entire image, so for such applications, no image construction will be needed. The processing steps after deblurring, such as binarization and OCR, are done on the individual sub-images.

In the case of continuous depth variation in the document image (see for example FIG. 2(a)), it is difficult to segment an image based on depth variations. In such a case, segmentation of the image into character blocks tends to dependent on arbitrarily defined boundaries. In a simple approach, the image is divided into many rectangular overlapping sub-images, and the sub-images are analyzed to obtain their local PSFs. In this way, discrete depth variations are used to approximate the continuous depth variation. The smaller the sizes of the sub-images are, the better the approximation of depth. However, it is better to have larger sub-image for deconvolution due to its boundary effects. Compromises must be made between the depth smoothness and deconvolution; the size of the sub-images should be significantly greater than the widths of the local PSFs.

When the sub-images are small, it is also possible that some sub-images contain no edges or the edges are too blurred to estimate the local PSFs. Such sub-images may be ignored for deblurring purpose as they probably contain no useful information, or deblurring is not capable of recovering the useful information. Alternatively, the PSFs of such sub-images can be calculated by predictions or interpolations using the PSFs of neighboring sub-images. The latter approach may be useful when perspective and depth information can be obtained from the image or a priori knowledge is available.

The above described method of adaptive deblurring using local PSFs derived from camera-based document images can significantly improve the overall image quality when the target document is not at a fixed depth from the camera.

The methods described above may be implemented in a data processing system which includes an image capturing section and an image processing section. One example of an image processing system, shown in FIG. 3(a), is a mobile device 30 such as a mobile phone which has an image capturing section 31 (i.e. a camera of the mobile phone) and an image processing section 32 (e.g. a microprocessor, hardware circuits, etc.). The deblurring methods described above may be implemented by software or firmware stored in a memory 33 and executed by the processor, or by hardware circuits. The image capturing section 31 and the image processing section 32 are located within the same housing of the mobile device 30. The mobile device typically also includes a communication section for communicating with an external device via a wireless or wired communication channel.

Another example of an image processing system, shown in FIG. 3(b), includes a digital camera 35 (which may be a camera phone) and a computer 36. The digital camera and the computer are separate devices and may be connected by a data communication channel such as a USB cable or a wireless link to transfer data between them. The camera 35 transfers the captured images to the computer 36, and the computer performs the deblurring methods described above by executing software programs stored in its memory.

It will be apparent to those skilled in the art that various modification and variations can be made in the image deblurring method of the present invention without departing from the spirit or scope of the invention. Thus, it is intended that the present invention cover modifications and variations that come within the scope of the appended claims and their equivalents.

What is claimed is:

1. A method implemented in a data processing system for processing a document image, comprising:
(a) obtaining a plurality of sub-images from the document image; and
(b) for each sub-image,
(b1) detecting a plurality of edges in the sub-image;
(b2) obtaining edge response functions by analyzing image intensity variations across the detected edges;
(b3) calculating two-dimensional point-spread function from the edge response functions; and
(d4) deblurring the sub-image by applying deconvolution with the calculated point-spread function.

2. The method of claim 1, wherein the plurality of sub-images overlap each other and collectively cover the entire document image.

3. The method of claim 3, further comprising:
(c) constructing a deblurred document image by combining the deblurred sub-images using image mosaicking.

4. The method of claim 1, wherein step (a) includes extracting sub-images containing information of interest from the document image.

5. The method of claim 4, wherein the sub-images are extracted using text classification.

6. The method of claim 1, wherein the plurality of edges detected in step (b1) includes a first plurality of edges substantially along a first direction and a second plurality of edges substantially along a second direction, wherein the second direction is substantially non-parallel to the first direction.

7. A computer program product comprising a computer usable medium having a computer readable program code embedded therein for controlling a data processing apparatus, the computer readable program code configured to cause the data processing apparatus to execute a process for processing a document image obtained by a camera, the process comprising:
(a) obtaining a plurality of sub-images from the document image; and
(b) for each sub-image,
(b1) detecting a plurality of edges in the sub-image;
(b2) obtaining edge response functions by analyzing image intensity variations across the detected edges;
(b3) calculating two-dimensional point-spread function from the edge response functions; and
(d4) deblurring the sub-image by applying deconvolution with the calculated point-spread function.

8. The computer program product of claim 7, wherein the plurality of sub-images overlap each other and collectively cover the entire document image.

9. The computer program product of claim 8, wherein the process further comprises:
(c) constructing a deblurred document image by combining the deblurred sub-images using image mosaicking.

10. The computer program product of claim 7, wherein step (a) includes extracting sub-images containing information of interest from the document image.

11. The computer program product of claim 10, wherein the sub-images are extracted using text classification.

12. The computer program product of claim 7, wherein the plurality of edges detected in step (b1) includes a first plurality of edges substantially along a first direction and a second plurality of edges substantially along a second direction, wherein the second direction is substantially non-parallel to the first direction.

13. A mobile device comprising:
an image capturing section for capturing an image; and
a processing section for processing the captured image, wherein the processing section obtains a plurality of sub-images from the document image, and for each sub-image, the processing section detects a plurality of edges in the sub-image, obtains edge response functions by analyzing image intensity variations across the detected edges, calculates two-dimensional point-spread function from the edge response functions, and deblurs the sub-image by applying deconvolution with the calculated point-spread function,
wherein the image capturing section and the processing section are contained within a same housing.

14. The mobile device of claim 13, wherein the plurality of sub-images overlap each other and collectively cover the entire document image.

15. The mobile device of claim 14, wherein the processing section further constructs a deblurred document image by combining the deblurred sub-images using image mosaicking.

16. The mobile device of claim 13, wherein the processing section extracts sub-images containing information of interest from the document image.

17. The mobile device of claim 16, wherein the sub-images are extracted using text classification.

18. The mobile device of claim 13, wherein the plurality of edges detected by the processing section includes a first plurality of edges substantially along a first direction and a second plurality of edges substantially along a second direction, wherein the second direction is substantially non-parallel to the first direction.
